(19) United States
(12) Patent Application Publication
(10) Pub. No.: US 2009/0273321 A1
(43) Pub. Date: Nov. 5, 2009

(54) DEVICE AND METHOD FOR CHARGING AN ENERGY STORE

(75) Inventors: Martin Götzenberger, Ingolstadt (DE); Alexander Reich, Pilsting (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/305,982

(22) PCT Filed: Apr. 20, 2007
(86) PCT No.: PCT/EP2007/053909

§ 371 Date: Dec. 22, 2008

(30) Foreign Application Priority Data
Jun. 21, 2006 (DE) 10 2006 028 503.4

(51) Int. Cl. H02J 7/00

(52) U.S. Cl. 320/166

(57) ABSTRACT

The energy required for equilibrating the charges of at least two cells in series in an energy storage device is introduced by way of a first charge path via an alternating voltage bus to the cell with the lowest cell voltage (U_{ZX}). The alternating voltage bus is supplied with power from an energy storage device by way of a DC converter and an AC converter. A second charge path can alternatively connect the DC converter connector which is connected to the AC converter, to a series circuit of several cells, in particular, all cells of the energy storage device.

The invention relates to a device and a method for charging an energy store, in particular an energy store which has a plurality of individual cells arranged in series, e.g. double-layer capacitors, such as those used in an electrical system of a motor vehicle, for example.

Electrical energy stores represent one of the main problems of hybrid technology in motor vehicles. There is firstly a requirement for energy stores having a high capacity, and secondly for these to be able to receive and provide high levels of power in the vehicle electrical system, sometimes for brief periods. For example, significant demands are made on the energy stores in the context of acceleration support (boosting the internal combustion engine) by means of an electrical machine working as an electromotor, or when converting kinetic energy into electrical energy by means of the electrical machine working as a generator in the context of regenerative braking (recuperation).

An energy store which meets the requirements in respect of a high level of power for brief periods is the double-layer capacitor, for example. The maximum voltage of an individual cell of a double-layer capacitor is limited to 2.5V to 3.0V, and therefore approximately 20 to 26 individual capacitors must be connected in series to form a capacitor stack for a voltage of e.g. 60V which is required in particular for what is termed a mild hybrid vehicle.

As a result of varying self-discharge of the individual cells, a charge imbalance in the capacitor stack occurs over time, and this charge imbalance would ultimately render the double-layer capacitor unusable after long service life if no charge equalization is effected.

In a known method for charge equalization of serially arranged individual cells of an energy store (WO 2006/000471 A1), energy is taken from the energy store or a further energy source and is used to charge an intermediate circuit capacitor. The voltage of the intermediate circuit capacitor is inverted by a DC/AC converter and this AC voltage is converted by means of a rectifier, via an AC voltage bus and a coupling capacitor, into a pulsating DC current which is then used for charging the cell that has the lowest cell voltage.

If the energy store comes to be fully discharged in specific operating situations, e.g. if a new energy store is installed or if the vehicle remains stationary for a long time, the charging of the double-layer capacitor is particularly difficult.

In the usual application scenario, the 14V vehicle electrical system can be supplied by the double-layer capacitor via a buck converter. This arrangement would also be suitable for charging the double-layer capacitor, but presupposes that the voltage of the double-layer capacitor does not fall below that of the vehicle electrical system. If the double-layer capacitor is fully discharged, however, it would be necessary to provide a second smaller buck converter via which the double-layer capacitor could be charged up to the voltage of the vehicle electrical system.

With the method described in the introduction and the device according to WO 2006/000471 A1 it is also possible to charge the cells via an external source. In the case of this charge equalization circuit, however, it proves disadvantageous that the charging of the double-layer capacitor is associated with a significant time overhead.

If a stack of 24 double-layer capacitors having a capacity of 1800 F each and a total current of 4 A is charged from the equalization circuit, for example, this gives a charge current of 0.167 A per cell. In the case of a 14V vehicle electrical system, 0.625V cell voltage per cell is required. This results in a charging time as follows:

t=U*C/I=0.625*1800 F/0.167 A=6750 s.

It follows that approximately 2 hours would be required for charging the double-layer capacitor. However, such a long time period is acceptable neither during the manufacturing nor during the subsequent use of the vehicle.

It is therefore the object of the invention to provide a device and a method which allow the charging of a double-layer capacitor to be simplified and accelerated.

The invention is achieved by the features recited in claims 1 and 8.

In the case of at least two serially connected cells of an energy store, with the aid of a first charge path, the energy that is required for equalizing the stored charges is supplied via an AC bus to the cell which has the lowest cell voltage in each case. In this case the AC bus is supplied with energy from an energy store via a DC voltage converter and an AC voltage converter.

According to the invention a second charge path is now provided which can alternatively connect the terminal of the DC voltage converter, said terminal being connected to the AC voltage converter, to a series-connected arrangement comprising a plurality of cells, in particular all cells of the energy store.

It is thus possible—particularly in the case of a largely empty energy store—for the charging of the same to take place initially or even exclusively via the second charge path.

Advantageous developments of the invention are specified in the dependent claims.

According to a first embodiment of the invention, the linking and potential separation of the cells can be effected by capacitive means, in particular via capacitors. Alternatively, the linking can be effected by means of inductive coupling elements, in particular via transformers.

The installation can be carried out easily by means of the bus system. The individual cells can be supplied via one or two AC voltage bus lines in particular. Only a few low-cost standard components are required for the circuit.

The selection of the charge path (first charge path or second charge path) can take place by means of a control unit, for example. In this case the control unit specifies the relevant charge path. This can be done e.g. on the basis of operating parameters of a motor vehicle, in particular the operating parameter of the energy store, of an internal combustion engine and/or of an electrical machine. According to a further embodiment of the invention, the charging process can take place via the second charge path initially, in particular until the instant when a specific cell voltage or voltage across the energy store is reached, and then continued via the first charge path.

It is advantageously possible thus, after an initially rapid charging via the second charge path, to provide for a symmetrization of the individual cells via the first charge path.

The circuit arrangement comprising the first and the second charge path is in particular suitable for integration in a housing of the individual cells or of the whole energy store.

Double-layer capacitors, which are also called supercaps or ultracaps, lithium-ion accumulators or lithium-polymer accumulators are particularly suitable as energy stores in this context.

Exemplary embodiments of the invention are explained in greater detail below with reference to schematic drawings, in which:

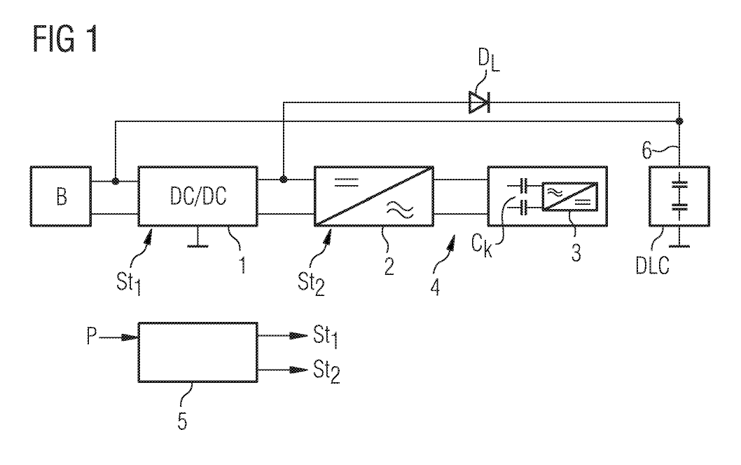

FIG. 1 shows a block schematic diagram of a basic circuit arrangement for charge equalization of cells of an energy store,

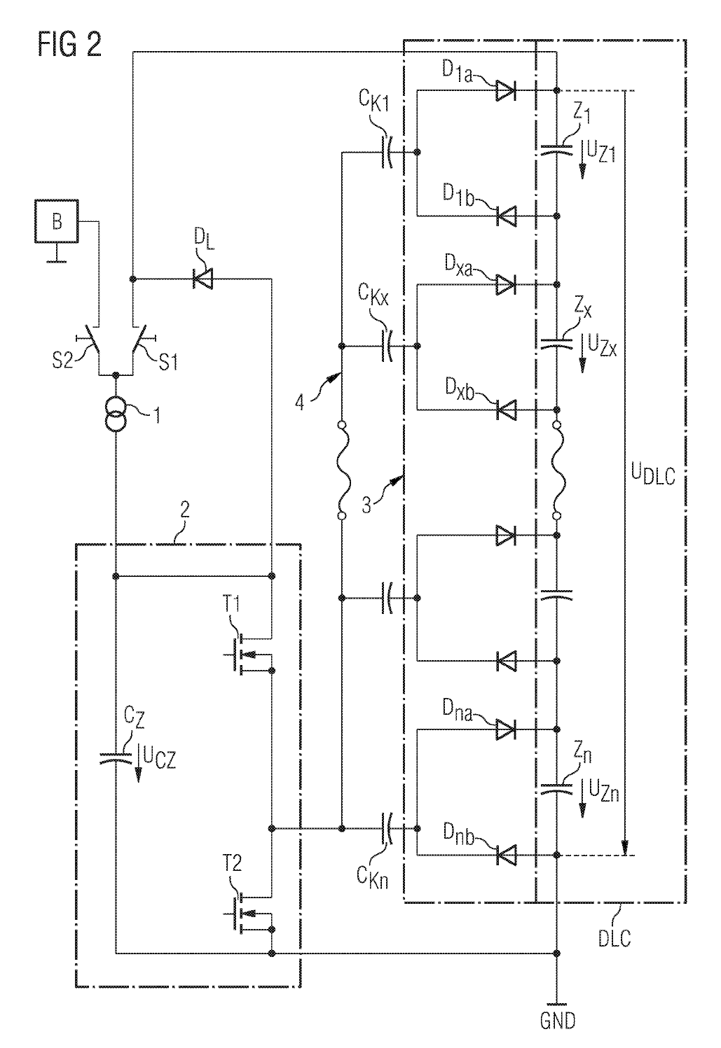

FIG. 2 shows a first exemplary embodiment of a charge circuit,

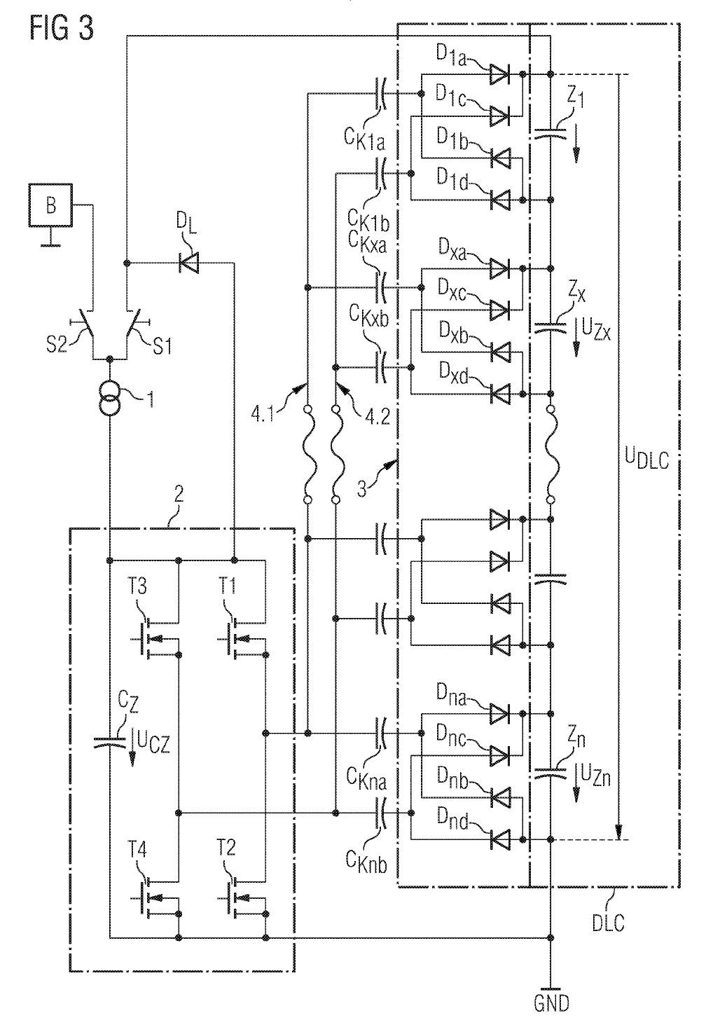

FIG. 3 shows a further exemplary embodiment of a charge circuit, and

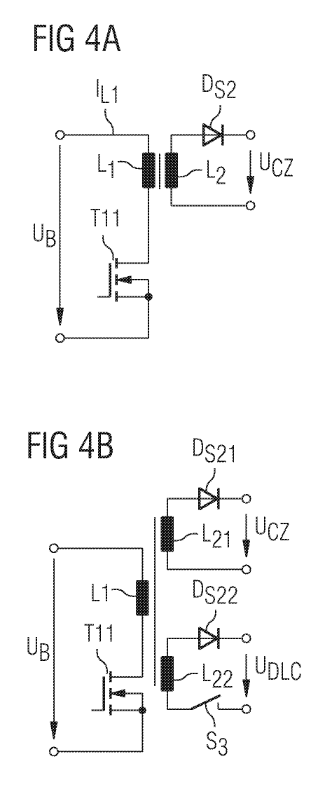

FIG. 4 shows an exemplary embodiment of a charge circuit comprising a flyback converter.

FIG. 1 shows a block schematic diagram of a basic circuit arrangement for charge equalization of cells of an energy store, e.g. a double-layer capacitor DLC. A DC voltage is generated by a first converter 1 and is inverted by means of a second converter 2 with a pulse frequency of 50 kHz, for example. This AC voltage is carried by an AC bus 4. A bus, in this context, is understood to refer to a system of conductors, in particular cables and copper rails. The series-connected cells Z₁ to Zₙ of the double-layer capacitor DLC are connected to said AC bus 4 via coupling capacitors C_{K} and rectifiers.

The first converter can be supplied with energy in this case from either an accumulator B or the double-layer capacitor DLC itself.

The charging of the double-layer capacitor DLC can in this case be effected via a first charge path which has the AC voltage converter 2, the coupling capacitor C_{K} and the rectifier 3. The basic principle of the first charge path with the associated charge equalization circuit is described in detail in the publication WO 2006/000471 A1, the full scope of which is herewith included in the present application.

Alternatively, a plurality of cells or even the whole cell stack can be charged via a second charge path. This charge path includes a diode D_{L} which connects the output of the first converter 1 to a terminal 6 of the double-layer capacitor DLC. At least two series-connected cells Z can be supplied with energy via said terminal 6. The diode D_{L} is polarized from the first converter 1 to the double-layer capacitor DLC in the flow direction.

The maximum settable current of the first converter 1 flows via the second charge path through the single diode D_{L} into the series-connected cells of the energy store and in this case is not divided by inversion, transference and subsequent rectification. The time period required for the charging can be significantly reduced in this way.

Voltage differences between the individual cells of the energy store DLC can then be equalized via the first charge path if necessary. To that end, the first converter 1 can be supplied by both the accumulator B and the double-layer capacitor DLC itself. The first converter has an input st₁ via which the corresponding energy source B or DLC can be selected.

Furthermore, the second converter 2 likewise has an input st₂ via which said converter 2 can be switched on and off. In the switched-off state, the output current of the first converter 1 flows exclusively via the second charge path.

The control signals st₁ and st₂ are generated by a control unit 5 as a function of parameters P. Possible parameters P are e.g. the individual cell voltages, the average of all cell voltages, the total voltage of the energy store or also operating parameters of the motor vehicle.

FIG. 2 shows a first exemplary embodiment of an inventive circuit arrangement for charge equalization of cells Z₁ to Zₙ of an energy store, this again being a double-layer capacitor DLC for example.

The circuit arrangement according to FIG. 2 likewise has two charge paths again, the first charge path via the AC bus 4 and the second charge path via the diode D_{L}.

The first exemplary embodiment, which is illustrated in FIG. 2, of an inventive circuit arrangement for the charge equalization of cells Z₁ to Zₙ of an energy store, in particular a double-layer capacitor DLC, has the individual cells Z₁ to Zₙ connected to form a series. The voltage U_{DLC} which is released from the series comprising the cells Z₁ to Zₙ is supplied to a DC voltage converter 1, in particular a current-controlled buck converter, via a first switch S1. An energy source, e.g. an accumulator B, can additionally or alternatively be connected to the DC voltage converter 1 via a second switch S2. The DC voltage converter 1 is in turn electrically connected to an input of an AC voltage converter 2 which in this exemplary embodiment comprises an intermediate circuit capacitor C_{Z} and two transistors T1 and T2 which are connected as a half-bridge arrangement. The intermediate circuit capacitor C_{Z} can be charged either by the double-layer capacitor DLC via the switch S1 or by the accumulator B via the switch S2. The output of said AC voltage converter 2 lies between the two transistors T1 and T2 and is electrically connected to the AC bus 4. The AC bus 4 in turn has a coupling capacitor C_{K1} to C_{Kn}, in each case for the cells Z₁ to Zₙ that are assigned to it.

A rectifier 3 is arranged between each coupling capacitor C_{Kx(x=1 . . . n)} and the cell Zₓ which is assigned to it, and here has two diodes Dₓₐ, D_{xb} in each case. The diodes Dₓₐ connect the coupling capacitor C_{Kx} terminal that is oriented away from the AC bus 4 in each case to the terminal having the higher potential (positive terminal) of the assigned cell Zₓ, and the diode D_{xb} connects said terminal of the coupling capacitor C_{Kx} to the terminal having the lower potential (negative terminal) of the assigned cell Zₓ.

According to the invention, the diode Dₓₐ is polarized from the coupling capacitor C_{Kx} to the positive terminal of the cell Zₓ in the flow direction, while the diode D_{xb} is polarized from the negative terminal of the cell Zₓ to the coupling capacitor C_{Kx} in the flow direction.

The AC voltage converter 2, which in this first exemplary embodiment consists of a half-bridge T1, T2, supplies a rectangular AC voltage at its output lying between the two transistors T1 and T2, wherein said rectangular AC voltage can be transferred to the individual cells Z₁ to Zₙ through the coupling capacitors C_{K1} to C_{Kn}.

Various capacitor types can be utilized for the coupling capacitors C_{K}. Capacitance, frequency and the internal loss resistance of the capacitors must be balanced, however. Incorrect balancing would result in excessive recharging of the coupling capacitors and hence persistently degrade the selectivity and discrimination of the equalization circuit.

The current is rectified again by means of the respective rectifier 3 and supplied to the respective cell Zₓ as charge current.

In order to be able to achieve a charge equalization at the series-connected cells Z₁ to Zₙ of the energy store, energy must be taken from the cell which has the highest voltage and supplied back to the cell Zₓ from which the least voltage is released, such that the cell Zₓ having the least voltage is charged. This process of charging via the first charge path, the charge equalization, is explained by way of example for the cell Zₓ which in this exemplary embodiment has the lowest cell voltage U_{Zx}. The coupling capacitor C_{Kx} is charged in the negative phase of the AC voltage signal (transistor T2 conductive) through the lower diode D_{xb} onto the lower potential (at the negative terminal) of the cell Zₓ—minus the forward voltage of the diode D_{xb}.

When the AC voltage signal subsequently lifts the potential to a sufficient extent (transistor 1 conductive), current flows from the intermediate circuit capacitor C_{Z} via the transistor T1, the AC bus 4, the coupling capacitor C_{Kx} and the diode Dₓₐ through the cell Zₓ and all cells whose positive terminal has a lower potential, relative to the reference potential GND, than the positive terminal of the cell Zₓ that is to be charged, i.e. the cells Zₓ₊₁ to Zₙ in this case, and from there back to the intermediate circuit capacitor C_{Z}.

In the subsequent negative phase of the AC voltage signal (transistor T2 conductive again), the current flows in the opposite direction through the cells whose positive terminal has a lower potential relative to the reference potential GND than the positive terminal of the cell Zₓ that is to be charged, i.e. the cells Zₙ to Zₓ₊₁, and then through the diode D_{xb} and the coupling capacitor C_{Kx}. The current circuit closes via the AC bus and the conductive transistor T2.

This causes a pulsating charging direct current to arise in the cell Zₓ while all cells Zₓ₊₁ to Zₙ whose positive terminals have a lower potential relative to the reference potential GND experience an alternating current.

The pulsating direct current can only flow into the cell Zₓ having the lowest cell voltage U_{Zx}, and then charges this cell first until said cell Zₓ has reached the next higher cell voltage of the other cells. The pulsating direct current is then divided between these two cells until they in turn reach the next higher cell voltage. In this way a charge equalization of the whole capacitor stack, i.e. all cells of the energy store DLC, is achieved.

The energy that is used to charge the respective cell Zₓ of the energy store DLC comes from the intermediate circuit capacitor C_{Z} which, by virtue of this load on one side and the constant recharging on the other side, independently adjusts itself to a suitable voltage U_{CZ}. In this case it also occurs automatically that the cell Zₓ at which the least voltage is released receives the most energy, while cells at which a higher cell voltage is currently being released do not receive any energy at all.

In the event that the whole energy store DLC is uncharged or discharged, charging of the energy store DLC via the first charge path, i.e. via the AC voltage converter 2, the AC bus 4, the coupling capacitor C_{K} and the rectifier 3, would require a significant period of time. The second charge path via the diode D_{L} now comes into effect. The diode D_{L} is connected on one side to the DC voltage converter 1 output that is oriented toward the AC voltage converter 2. On the other side the diode D_{L} is connected to the positive terminal of the energy store DLC such that a plurality of cells Z₁ to Zₙ, these all being connected in particular in series as illustrated here, can be charged via the second charge path. In this case the diode D_{L} is polarized from the output of the DC voltage converter 1 to the positive terminal of the energy store DLC in the flow direction.

If the case described in the introduction now occurs, both the transistor T1 and the transistor T2 are switched off via a control unit ST (see FIG. 1), such that the DC voltage converter 1 can charge all cells of the energy store. In order to achieve this, the DC voltage converter 1 can be activated in such a way that the energy store charges with its maximum settable current. If the cell stack—e.g. comprising 24 individual cells—is charged via the diode D_{L} with a current of 4 A at a voltage of 13V, for example, this means a charging time of t=13V:24×1800 F:4 A=4 minutes. In order now to charge the cell stack fully to its rated voltage of 15V, an additional charge duration of 15 minutes via the first charge path is required in a similar manner to the above calculation. The whole cell stack is therefore fully charged in 19 minutes. Such a charging time is acceptable for the first use or replacement of the energy store.

Energy is taken from the accumulator B by the DC voltage converter 1 by way of the second charge path and supplied in sum to the energy store DLC.

For this purpose it is not necessary to change the components of the DC voltage converter 1, since the currents are not changed in comparison with the conventional operation of the equalization circuit—charging or charge equalization via the first charge path. In this case the increased output power of the DC voltage converter 1 results from the higher output voltage of the same. In order to activate the second charge path it is sufficient to switch off the transistors T₁ and T₂ of the half-bridge of the AC voltage converter 2. It is therefore possible to accelerate the charging of the energy store DLC significantly in a simple manner by adding a single component, the diode D_{L}.

FIG. 3 shows a second exemplary embodiment of the inventive circuit arrangement which has an AC voltage converter 2 with a full bridge and a (Graetz rectifier) in a two-phase variant. In this case too it is again assumed that the cell Zₓ is the cell which has the lowest cell voltage U_{Zx}.

Functionally identical parts bear the same reference signs here as in FIG. 2.

In this exemplary embodiment the first charge path has two phases. It functions in a similar manner to the circuit of the previously described exemplary embodiment which had one half-bridge and one phase as illustrated in FIG. 2. However, the two-phase AC voltage converter 2 according to FIG. 3 has certain advantages which still outweigh the additional expense depending on the application scenario.

The AC voltage converter 2 has a full bridge circuit with two half-bridges here. The first half-bridge has a first and a second transistor T1, T2, and the second half-bridge a third and a fourth transistor T3 and T4. The outputs of the two half-bridges are connected in each case to a bus line 4.1 or 4.2. Each bus line 4.1, 4.2 is supplied with energy via the half-bridge which is assigned to it.

The bus line 4.1 is connected to the series-connected cells Z₁ to Zₙ in each case via a coupling capacitor C_{K1a} to C_{Kna} and a rectifier circuit which comprises two diodes D₁ₐ, D_{1b} to Dₙₐ, D_{nb} in each case. The bus line 4.2 is likewise connected to the series-connected cells Z₁, Zₙ in each case via a coupling capacitor C_{K1b} to C_{Knb} and a rectifier circuit which comprises two diodes D_{1c}, D_{1d} to D_{nc}, D_{nd} in each case.

Again described with reference to the example of the cell Zₓ, this means that the bus line 4.1, which is connected to the half-bridge T1, T2, is connected via the coupling capacitor C_{Kxa} on one side via the diode Dₓₐ, this being conductive toward the cell, to the positive terminal of the cell Zₓ and on the other side via the diode D_{xb}, this being conductive toward the coupling capacitor, to the negative terminal of the cell Zₓ. In addition, the bus line 4.2, which is connected to the half-bridge T3, T4, is connected via the coupling capacitor C_{Kxb} on one side via the diode D_{xb}, this being conductive toward the cell, to the positive terminal of the cell Zₓ and on the other side via the diode D_{xd}, this being conductive toward the coupling capacitor C_{Kxb}, to the negative terminal of the cell Zₓ.

The two rectifiers Dₓₐ, D_{xb}, D_{xc}, D_{xd} therefore work in parallel on the cell Zₓ. The circuit arrangement is realized in a functionally identical manner for the remaining cells. An essential advantage in the case of two phases is that the alternating current does not pass through the cells which are not actually involved and are not being charged at present, i.e. all cells whose positive terminal has a lower potential relative to reference potential GND but a higher cell voltage U_{z} than the cell Zₓ (i.e. all other cells in this case).

In this second exemplary embodiment the two half-bridges work in phase opposition, i.e. when the transistors T1 and T4 are conductive in the first phase, the transistors T2 and T3 are non-conductive. The converse applies in the second phase, when the transistors T2 and T3 are conductive while the transistors T1 and T4 are non-conductive.

In the second exemplary embodiment likewise, a second charge path is again provided via a diode D_{L}. This is connected firstly to the output of the DC voltage converter 1 and secondly to the terminal of the cell stack. In this exemplary embodiment also, the whole cell stack can again be charged via the diode D_{L}—in the event that both half-bridges are switched off—directly by way of the DC voltage converter 1. The symmetrization or recharging can take place via the first charge path accordingly, i.e. the two-phase AC bus 4.1, 4.2 here.

With respect to the dimensioning of the diode D_{L}, it is important only that the diode D_{L} must be able to block the voltage UDLC of the energy store and to carry the charge current. Conventional power diodes are suitable for this. It is a further advantage of the invention that the components of the circuit arrangement can be arranged more effectively, since the buck converter per se is defined by its current.

FIGS. 4a and 4b each show a schematic illustration of a DC voltage converter 1 which is embodied as a flyback converter. FIG. 4a shows a first exemplary embodiment of a flyback converter in which both the input side and the output side of a storage transformer have a winding in each case. The accumulator B is connected therein to a series arrangement of the primary coil L1 and a transistor T₁₁. A secondary winding L2 is arranged on the output side and is electrically connected to the AC voltage converter 2 according to FIGS. 2 and 3. The transistor T₁₁ works here as a switch which is switched on and off by means of a pulse-width modulated control voltage. While the transistor T₁₁ is switched on, the voltage across the primary winding L₁ is equal to the input voltage U_{B} and the current I_{L1} increases linearly. During this phase, energy is charged into the storage transformer. The secondary winding L2 is currentless in this phase due to blocking by the diode D_{S2}. If the transistor T₁₁ is now blocked, the current flow through the primary winding L₁ is interrupted and the voltages at the transformer reverse their polarity due to the law of induction. The diode D_{S2} now becomes conductive and the secondary winding L₂ delivers the energy via the output terminals of the secondary side.

FIG. 4b shows a second exemplary embodiment of a flyback converter comprising a storage transformer which has two secondary windings L₂₁ and L₂₂ on the secondary side. The first secondary winding L₂₁ supplies energy to the AC voltage converter 2 as per the exemplary embodiment according to FIG. 4a. The second secondary winding L₂₂ supplies energy to individual subgroups of cells or even to the whole cell stack. In this exemplary embodiment, a switch S3 by means of which the charging of the cell stack via the second charge path can be switched on or off is provided in the current circuit of the second secondary winding L22.

Via said second winding L₂₂ it is possible to supply a higher voltage in comparison with the accumulator voltage. Therefore the energy store can also be fully charged without assistance from the first charge path. The charging time is thereby again significantly reduced.

The utilization of a flyback converter as an AC voltage converter has further advantages, e.g. the pulse duty ratio for the use of the charge equalization circuit can be selected to be more favorable than in the case of a conventional buck converter which has to provide a cell voltage U_{Zx} of e.g. 2.5V from a total energy store voltage U_{DLC} of e.g. 60V.

1-9. (canceled)

10. A charging device for charging individual cells of an energy storage device, the cells being connected in series, the charging device comprising:
a DC/DC voltage converter connectible to an energy storage device);
an AC voltage converter connected downstream of said DC/DC voltage converter, said AC voltage converter having an intermediate circuit capacitor and a bridge configuration;
at least one AC bus connected downstream of said AC voltage converter;
a series configuration comprising at least one coupling element and a rectifier connected between each cell of the energy storage device and each said AC bus, said AC bus together with said coupling element and said rectifier forming a first charge path;
a second charge path disposed to connect a terminal of said DC/DC voltage converter oriented toward said AC voltage converter to a series circuit of at least two cells of the energy storage device.

11. The device according to claim 10, wherein said second charge path includes a diode with a forward flow direction oriented from an output of said DC/DC voltage converter toward a terminal of the energy storage device.

12. The device according to claim 10, wherein said coupling element is an inductive coupling element or a capacitive coupling element.

13. The device according to claim 10, which further comprises a control unit for selectively activating said first charge path or said second charge path.

14. The device according to claim 13, wherein said control unit is configured to select the respective charge path on the basis of a parameter.

15. The device according to claim 14, wherein the parameter is one or more of an electrical voltage released from the energy storage device, a cell voltage, an average of a plurality of cell voltages, and an operating parameter of a motor vehicle.

16. The device according to claim 10, which further comprises a housing commonly enclosing the charging device together with the energy storage device.

17. A method for charging individual cells of an energy storage device, the cells being connected in series, the method which comprises:
charging the energy storage device via a first charge path or a second charge path in dependence on a parameter;
when the first charge path is selected, charging the energy storage device via an AC voltage, and supplying a rectified pulsating charge current to a cell having the lowest cell voltage; and
when the second charge path is selected, charging a series circuit of at least two cells of the energy storage device using a DC voltage, and supplying a direct current to the series-connected cells.

18. The method according to claim 17, which comprises, when the second charge path is selected, charging the series circuit of all cells of the energy storage device.

19. The method according to claim 17, wherein the parameter is one or more of an electrical voltage released from the energy storage device, a cell voltage, an average of a plurality of cell voltages, and an operating parameter of a motor vehicle.
